(19) United States
(12) Patent Application Publication
(10) Pub. No.: US 2025/0344645 A1
(43) Pub. Date: Nov. 13, 2025

(54) GERMINATION UNIT

(71) Applicant: PB TECHNIEK B.V., Maasdijk (NL)

(72) Inventor: Koenraad Hedricus Maria BRABANDER, Maasdijk (NL)

(73) Assignee: PB TECHNIEK B.V., Maasdijk (NL)

(21) Appl. No.: 18/862,280

(22) PCT Filed: May 2, 2023
(86) PCT No.: PCT/NL2023/050237

§ 371 Date: Nov. 1, 2024

(30) Foreign Application Priority Data
May 2, 2022 (NL) 2031752

(51) Int. Cl. A01G 9/029; A01G 9/14

(52) U.S. Cl. CPC A01G 9/0299; A01G 9/14

(57) ABSTRACT

A germination unit for a rotating horticultural growing system receives or comprises a guide for guiding a plurality of cultivation receptacles in a transport direction. The germination unit includes an enclosure for providing a controllable climate for the germination of crops. An input of the enclosure allows a cultivation receptacle to be introduced into the enclosure and onto an input of the guide. An output of the enclosure allows the cultivation receptacle to leave the enclosure in the transport direction. An offset between the input of the guide and the output of the enclosure defines a total capacity of cultivation receptacles that may be simultaneously housed inside the enclosure. The offset is selectively adjustable to allow a retention time of the cultivation receptacles in the enclosure to be set. A rotating horticultural growing system including a germination unit and a method for growing a crop using a germination unit.

The present invention relates to a germination unit of or for a rotating horticultural growing system of the type used in agricultural greenhouses. The present invention furthermore relates to a rotating horticultural growing system comprising such a germination unit and a corresponding method for growing crops.

Rotating horticultural growing systems are highly efficiency systems in which crops are grown in a continuous, rotating manner from a seed or seedling to a fully grown crop ready for harvesting. In such systems, crops in the form of seeds or seedlings are disposed in cultivation receptacles that are slowly transported in a transport direction from one end of the cultivation system to an opposite other end thereof. By the time the crops have reached the opposite other end of the cultivation system, the crops will have fully matured to the point at which they are ready for harvesting.

The above rotating horticultural growing system systems typically comprise a large number of cultivation receptacles, each of which comprising crops at various stages of development. When crops in a given cultivation receptacle have reached the end of their growth cycle, the cultivation receptacle is removed from the aforementioned opposite other end of the cultivation system for harvesting. After harvesting of the crop and cleaning of the cultivation receptacle, new seeds or seedlings are disposed into the cultivation receptacle and the cultivation receptacle is placed back into the cultivation system to start another growth cycle.

The here above described horticultural cultivation systems thus allow for an uninterrupted, continuous method for growing crops in which the cultivation receptacles are continuously rotated. In order to maintain a high production efficiency, cultivation receptacles that are removed from the cultivation system for harvesting are immediately placed back into the cultivation system to start a new growth cycle, so that the cultivation system is operating at full capacity at all times. The duration of a growth cycle of a crop—i.e. the time between the start of germination and harvesting—is species dependent, meaning that it varies from one type of crop to another. As such, when a horticulturalist intents to cultivate another species of crop, the rotating horticultural growing systems must be reconfigured so that the transport speed, with which the cultivation receptacles are transported along the cultivation trajectory, matches the duration of the growth cycle of the crop. Furthermore, the duration of a growth cycle of a crop is also dependent on the environmental conditions within the greenhouse. These conditions may fluctuate over time and thereby shorten or lengthen the duration of the growth cycle. In particular the amount of daylight hours—which e.g. increases in the first half of the year and decreases in the second half of the year in Europe—is known to significantly affect the duration of the growth cycle. When the duration of the growth cycle is shortened due to an increased amount of sunlight hours, the rotating horticultural system must be reconfigured so that the transport speed is increased. Likewise, in case of a decreased amount of sunlight hours, the transport speed of the rotating horticultural system must be increased to account for the correspondingly decreased growth cycle duration.

The here above described rotating horticultural growing systems typically comprise transport members configured to periodically move the cultivation receptacles over a given distance within the system along a guide. These transport members are typically computer controlled, which allows for easy adjustment of—for example—the time intervals at which cultivation receptacles are displaced. As such, any variations in the length of the growth cycle of the crops that result from changes in the environmental conditions within the greenhouse may be easily accounted for, at least for the period of the growth cycle when the crops are exposed to the conditions within the greenhouse.

In the here above described rotating horticultural systems, germination of the crops at the beginning of the growth cycle usually takes place in a specialised germination unit. A germination unit comprises an enclosure in which environmental conditions such as temperature, humidity and amount of light can be accurately controlled to provide an optical climate for germination of crops independently of the conditions within the rest of the greenhouse. Because most seeds germinate best under dark conditions, a wholly dark environment is typically maintained within the germination unit.

The duration of the here above germination phase within a germination unit is likewise dependent on the species of crop that is cultivated. However, because the climate within the germination unit is kept substantially constant at all times, the duration of the germination phase is unaffected by seasonal variations of the conditions within the rest of the greenhouse.

There therefore exists a “mismatch” between on the one hand the relatively fixed duration of the germination phase and on the other hand variations in the overall duration of a growth cycle of a crop. In rotating horticultural systems that are intended to function at maximum capacity at all times, this “mismatch” results in complications with respect to (re)configuring the rotating horticultural system to account for these variations in growth cycle duration.

The objective of the present invention is to provide a means with which such complications are avoided or abated.

This objective is achieved with a germination unit according to the present invention, the germination unit being of or for a rotating horticultural growing system, configured to receive or comprise a guide that is configured to guide a plurality of cultivation receptacles in a transport direction, said germination unit comprising an enclosure configured to provide a controllable climate for the germination of crops and to allow a cultivation receptacle to be introduced into the enclosure and onto an input of the guide, an output of the enclosure that is arranged downstream of the input of the guide and configured to allow the one or more than one cultivation receptacle to leave the enclosure in the transport direction, wherein an offset between the input of the guide and the output of the enclosure defines a total capacity of cultivation receptacles that may be simultaneously housed inside the enclosure, and wherein said offset is selectively adjustable to thereby allow a retention time of the cultivation receptacles in the enclosure to be set.

With the germination unit according to the present invention a retention time of cultivation receptacles within the germination unit may be set in correspondence with a transport speed of said cultivation receptacles within the rotating horticultural growing system, which is in dependent on seasonal changes of the climate within the greenhouse and the type of crop. When this transport speed increases, the offset may be adjusted to be correspondingly enlarged. The retention time of the cultivation receptacles within the germination unit then matches the transport speed and the shortened growth cycle time of the crops. Likewise, when the transport speed is decreased to compensate for an extended growth cycle time of the crops, the offset may adjusted to be correspondingly decreased. Simultaneously, the length of the overall transport trajectory within the germination unit and the capacity of the germination unit in terms of the number of cultivation receptacles that can be simultaneously housed therein can be increased or decreased.

The germination unit according to the present invention therefore makes it possible to flexibly respond to variations in the climate within the greenhouse, while simultaneously keeping the retention time of seeds and seedlings within the germination unit approximately constant independently of the (seasonally) changing conditions in the greenhouse. As such, the rotating horticultural growing system may operate at maximum efficiency at all times, with no unfilled spaces for cultivation receptacles being present, and seeds or seedlings being contained within the controlled climate of the germination unit for a predetermined retention time for optimal germination.

In a preferred embodiment of the germination unit according to the present invention, the output is arranged in a displaceable wall of the enclosure.

In a further preferred embodiment of the germination unit according to the present invention, the germination unit comprises at least one retractable wall connected to the displaceable wall.

In a further preferred embodiment of the germination unit according to the present invention, the displaceable wall extends along only a part of a height of the germination unit.

In a further preferred embodiment of the germination unit according to the present invention, the germination unit comprises at least two retractable walls.

In a further preferred embodiment of the germination unit according to the present invention, the displaceable wall is interposed between the at least two retractable walls.

In a further preferred embodiment of the germination unit according to the present invention, the displaceable wall comprises a longitudinal slot configured to allow cultivation receptacles to be transversely displaced therethrough.

In a further preferred embodiment of the germination unit according to the present invention, the longitudinal slot is angularly disposed in the displaceable wall.

In a further preferred embodiment of the germination unit according to the present invention, a circumference of the longitudinal slot is dimensioned in correspondence with a contour of a cultivation receptacle of the rotating horticultural growing system to be displaced therethrough.

In a further preferred embodiment of the germination unit according to the present invention, the enclosure comprises at least one material from a group of materials, said group comprising a thermally insulating material and a translucent material.

The objective of the present invention is furthermore achieved with a rotating horticultural growing system, comprising a guide configured to guide a plurality of cultivation receptacles in a transport direction, and a germination unit according to one or more than one of the foregoing embodiments.

In a preferred embodiment of the rotating horticultural growing system according to the present invention, a displaceable wall of the germination unit in accordance with the present invention defines a partition between a climate controlled germination section and a non-climate controlled growing section of the rotating horticultural growing system.

The objective of the present invention is furthermore achieved with a method for growing a crop, the method comprising at least the steps of providing a controllable climate for the germination of crops inside an enclosure of a germination unit, wherein the enclosure defines a total capacity of cultivation receptacles that may be simultaneously housed therein, and adjusting an interior space of the enclosure of the germination unit by adjusting an offset between an input of a guide and an output of the enclosure in dependence of a growth cycle duration of the crop.

In a preferred embodiment of the method for growing a crop according to the present invention, the step of adjusting the interior space comprises displacing a displaceable wall of the enclosure that comprises the output.

In a further preferred embodiment of the method for growing a crop according to the present invention, the germination unit is a germination unit according to one or more than one of the

The present invention will be elucidated here below with reference to the drawing, in which:

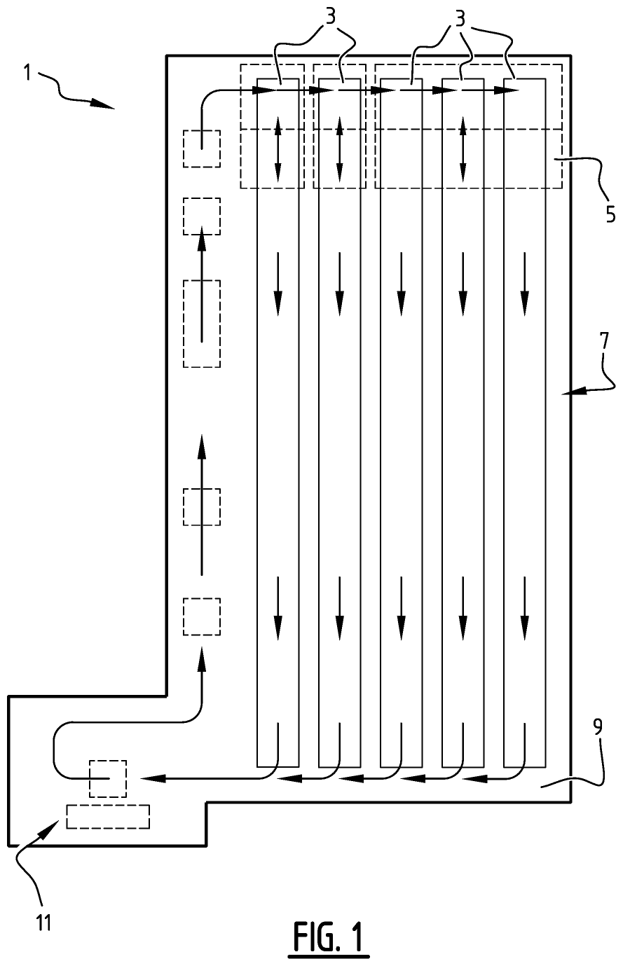

FIG. 1 depicts a top-down view of the general principle of a rotating horticultural growing system to which the present invention is applicable;

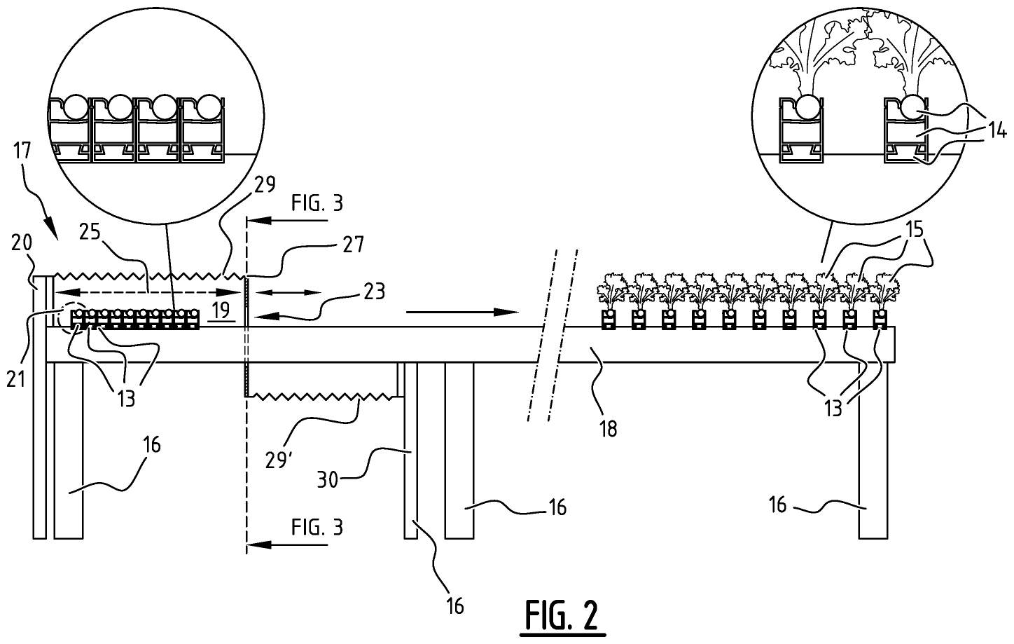

FIG. 2 shows a cross-sectional sideview of the rotating horticultural growing system of FIG. 1 in accordance with the present invention; and

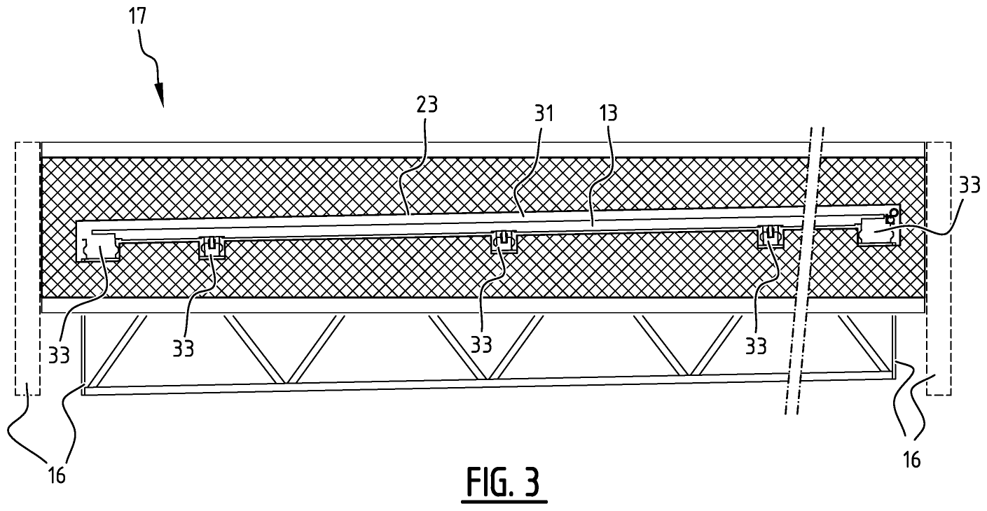

FIG. 3 shows a frontal view of a germination unit of FIG. 2.

Referring now to FIG. 1, a rotating horticultural system 1 arranged in a greenhouse comprises a number of rows 3 of cultivation receptacles 13 (see FIG. 2) parallelly lined up one after the other. Over the course of a growth cycle of crops 15 that are arranged in these cultivation receptacles 13, the cultivation receptacles 13 are moved in a transport direction indicated by the downward arrows from one end of the rotating horticultural cultivation system 1 to an opposing other end thereof.

Cultivation receptacles 13 comprising seeds to be germinated enter the rotating horticultural cultivation system 1 at a germination section 5, which in FIG. 1 is indicated by the dashed line boxes. Germinating seeds require a climate that differs from a climate within the rest of the greenhouse to ensure germination. The germination section 5 therefore comprises a germination unit 17 within which a controllable climate is maintained for optimal germination. The germination unit 17 will be elucidated here below with reference to FIG. 2 and FIG. 3.

Upon exiting the germination section 5, the seeds contained in the cultivation receptacles 13 will have germinated and the resulting seedlings are exposed to the climate within the greenhouse. Over the course of the remainder of the growth cycle of the crops 15, the cultivation receptacles 13 are slowly moved to an opposite other end of the rotating horticultural growing system 1 in the transport direction indicated by the downward arrows in FIG. 1. The rotating horticultural growing system 1 may comprise a transport system for this purpose that periodically moves each of the cultivation receptacles 13 over a predetermined distance.

Opposite the germination section 5 there is arranged a removal section 9. Crops 15 must be sufficiently matured for harvesting by the time they have reached the removal section 9. As such, a transport speed of the rotating horticultural growing system 1 must be set to match the duration of a growth cycle of the crops 15. At the removal section 9, cultivation receptacles 13 are removed from the rotating horticultural growing system 1 and transported to a harvesting section 11 where the crops 15 are harvested and the cultivation receptacles 13 are cleaned out and decontaminated. If a substrate-based growing method is used, the cultivation receptacles 13 may be refitted with growth substrate. Finally, the cultivation receptacles 13 are reseeded and placed back into the germination section 5 of the rotating horticultural growing system 1 to reiterate the growth cycle. Removal of cultivation receptacles 13 from the rotating horticultural growing system 1 and (re)introduction of reseeded cultivation receptacles 13 is preferably done at approximately the same time, so that the rotating horticultural growing system 1 at all times operates at maximum capacity with no ‘gaps’ being present in any the rows 3 of cultivation receptacles 13.

FIG. 2 shows cross-sectional sideview of the rotating horticultural cultivation system 1 in accordance with the present invention, showing a single row 3 of cultivation receptacles 13. As can be discerned from this figure, the rotating horticultural cultivation system 1 comprises a transport guide 18 along which cultivation receptacles 13 containing crops 15 at various stages of development are transported in the transport direction. The cultivation receptacles 13 comprise an internal structure with one or more internal spaces 14 to, for example, accommodate water or growing substrate for the crops 15 or to engage the guide 18. The rotating horticultural growing system 1 moreover comprises supports 16 that support the cultivation troughs 13 some distance above a ground level.

As shown at the left-handed side of FIG. 2, the rotating horticultural cultivation system 1 comprises a germination unit 17. The germination unit 17 is arranged at the germination section 5 as shown in FIG. 1 and has cultivation receptacles 13 with seeds to be germinated arranged within it. The cultivation receptacles 13 may be arranged directly adjacent to one another to maximise the number of cultivation receptacles 13 arranged within the germination unit 17 and to provide mutual support. As the crops 15 mature and grow, an intermittent distance between subsequent cultivation receptacles 13 may be gradually increased to account for the increasing dimensions of the crops 15.

The germination unit 17 comprises an enclosure 19 that separates an interior of the germination unit 17 from an exterior thereof within the greenhouse. The enclosure 19 either comprises a guide 18 (e.g. a guide of a transport system) that is configured to guide a plurality of cultivation receptacles 13 in a transport direction or is configured to receive such a guide 18 therein. Within the confines of the enclosure 19, a controllable climate is provided that is optimised for germination of the crop seeds different from a climate within the rest of the greenhouse. In particular the temperature, humidity and/or light within the germination unit 17 may be controlled for this purpose. The enclosure 19 may comprise a thermally insulating material or a translucent material for this purpose, or a combination of such materials.

Within the enclosure 19 of the germination unit 17 there exists an input 21 of the guide 18 that is comprised by, or received into, the enclosure 19. The input 21 of the guide 18 is configured to receive a cultivation receptacle 13 therein or thereupon and guide said cultivation receptacle 13 in the transport direction. The input 21 of the guide 18 may be defined as being the location within the germination unit 17 that is furthest away from the removal section 9 of the rotating horticultural cultivation system 1 and an output 23 of the germination unit 17. In other words, the input 21 of the guide 18 is the first among all of the possible positions at which a given cultivation receptacle 13 can be placed on or within the germination unit 17 of the rotating horticultural cultivation system 1, when viewed in the transport direction.

In embodiments wherein the horticultural cultivation system 1 comprises a transport system with a transport guide 18, the input 21 may coincide with an extreme end section of the transport guide 18 upon which the cultivation receptacles 13 are arranged. Alternatively, the input 21 may coincide with a location within the germination unit 17 directly adjacent to a backwall 20 of the enclosure 19 arranged opposite the aforementioned output 23 of the enclosure 19.

A distance between on the one hand the input 21 of the guide 18 and on the other hand the output 23 of the enclosure 19 determines a capacity of the germination unit 17 in terms of the number of cultivation receptacles 13 that can be arranged therein, and consequently also a length of a sub-trajectory along which cultivation receptacles 13 are transported within germination unit 17; said sub-trajectory forming part of an overall transport trajectory of the rotating horticultural cultivation system 1. Within the context of the present invention and disclosure, this distance is referred to as a (horizontal) offset 25 between the input 21 and the output 23.

After germination of the crop seeds, cultivation receptacles 13 exit the enclosure 19 of the germination unit 17 via the output 23, which is arranged in a displaceable wall 27 of the enclosure 19. The output 23 will be elucidated here below with reference to FIG. 3.

The displaceable wall 27, having arranged therein the output 23, is displaceable relative to the rest of the structure of the germination unit 17. The displaceable wall 27 may be displaced in either horizontal direction, to thereby shorten or lengthen the sub-section of the cultivation trajectory within the germination unit 17, and correspondingly also the capacity of the germination unit 17 in terms of the number of cultivation receptacles 13 that can simultaneously be housed therein.

To ensure that the enclosure 19 remains substantially closed to maintain the climate within the germination unit 17 when the displaceable wall 27 is displaced, the enclosure 19 comprises one or more retractable walls 29 connected to the displaceable wall 27. In the preferred depicted embodiment, the retractable walls 29 comprises a bellow mechanism than can fold or unfold on itself. Nevertheless, alternative solutions involve usage of flexible materials or adjacently arranged panels configured to slide past one another are likewise conceivable.

As can be discerned from FIGS. 2 and 3, the displaceable wall 27 extends along only a part of a height of the germination unit 17 and is interposed between two retractable walls 29 and 29′, which are arranged on opposite sides thereof. Here, the first retractable wall 29 extends from the backwall 20 to the displaceable wall 27 and the second retractable wall 29′ extends from the displaceable wall 27 to a front wall 30 of the germination unit 17.

The advantages of this configuration of the germination unit 17 are twofold. Firstly, the dimensions and weight of the displaceable wall 27 are minimised, which allows for relatively easy displacement of the displaceable wall 27. Displacement of the displaceable wall 27 may be done either manually or by means of an actuator (not shown). Secondly, a change in an internal volume of the germination unit 17 when the displaceable wall 27 is displaced is likewise minimised. When the displaceable wall 27 is moved to increase the aforementioned offset 25, an internal volume of the germination unit 17 is increased. Because the germination unit 17 maintains a controllable climate optimised for germination within this internal volume, this added volume must be brought into conformity with the rest of the internal volume by treating it by heating and/or moisturising it. As this treatment requires additional resources (i.e. energy required for performing this treatment), minimising this added volume of the germination unit 17 results in additional costs savings.

FIG. 3 shows a frontal view of a germination unit 17 when viewed along the dotted line of FIG. 2. As is clearly depicted in this figure, the output 23 of the enclosure 19 is formed as a longitudinal slot 31 configured to allow cultivation receptacles 13 to be displaced therethrough. In rotating horticultural cultivation systems of the type as described in the present disclosure, cultivation receptacles 13 may be arranged at an angle to passively facilitate the flow of water and nutrients through one of the internal spaces 14 of the cultivation receptacles 13. The longitudinal slot 31 is thus angularly disposed in the displaceable wall 27 at a corresponding angle.

A circumference of the longitudinal slot 31 is preferably dimensioned in correspondence with a lateral contour of the cultivation receptacles 13, which during operation of the rotating horticultural growing system 1 moves through longitudinal slot 31 with only minimal mechanical play. This configuration of the longitudinal slot 31 ensures that the controllable climate for the germination of crops 15 within the enclosure 19 of the germination unit 17 can be maintained with relative ease, because the tight fit between the cultivation receptacles 13 and the longitudinal slot 31 forms a seal isolating the interior of the germination unit 17 from the external environment.

Notwithstanding the above, the longitudinal slot 31 may comprise some additional recesses 33 that deviate from the here above described contour of the cultivation receptacles 13 to accommodate certain components of the rotating horticultural cultivation system 1, including transport members, the guide 18, or actuators for displacing the cultivation receptacles 13 in the transport direction.

A rotating horticultural growing system 1 as described here above comprising a germination unit 17 in accordance with the present disclosure is likewise considered to be part of the present invention. In such a rotating horticultural growing system 1, the displaceable wall 27 defines a partition between the climate controlled germination section 5 and a non-climate controlled growing section of the rotating horticultural growing system 1 that exists within the rest of the greenhouse.

While the present invention has been elucidated here above with reference to the germination unit 17 and the rotation horticultural growing system 1, the present invention also encompasses a method for growing (cultivating) a crop. This method for growing a crop comprises at least the steps of providing a controllable climate for the germination of crops inside an enclosure 19 of the germination unit 17, wherein the enclosure 19 defines a total capacity of cultivation receptacles 13 that may be simultaneously housed therein, and adjusting an interior space of the enclosure 19 of the germination 17 unit by adjusting the offset 25 between the input 21 of the guide 18 and an output 23 of the enclosure 19 in dependence of a growth cycle duration of the crop.

In the above method, the step of adjusting the interior space preferably comprises displacing a displaceable wall 27 of the enclosure 19 that comprises the output 23, which may be performed with a germination unit 17 according to the present invention.

The skilled person will recognise that many adjustments and modifications may be made to rotating horticultural growing system 1 and the germination unit 17 without departing from the basic principles of the present invention as defined in the claims. For example, while the above described cultivation receptacles 13 comprise a longitudinal shape resembling a trough or gutter, these cultivation receptacles 13 may alternatively comprise any alternative shape known within the Art suitable for accommodating crops 15. Moreover, the present invention is equally applicable to many of the known sub-types of rotating horticultural growing systems known within the Art, including substrate based and non-substrate based systems, such as Nutrient Film Technique (NFT) based systems. The scope for which protection is sought is therefore not limited to any one or more of the hereabove disclosed embodiments of the present invention, but is defined solely by the features specified in the appended claims and, at least in certain jurisdictions, their equivalents.

1. A germination unit of or for a rotating horticultural growing system, configured to receive or comprise a guide that is configured to guide a plurality of cultivation receptacles in a transport direction, said germination unit comprising:
an enclosure configured to provide a controllable climate for the germination of crops and to allow a cultivation receptacle to be introduced into the enclosure and onto an input of the guide;
an output of the enclosure arranged downstream of the input of the guide and configured to allow the one or more than one cultivation receptacle to leave the enclosure in the transport direction, wherein the output is arranged in a displaceable wall of the enclosure; and
at least one retractable wall connected to the displaceable wall;
wherein an offset between the input of the guide and the output of the enclosure defines a total capacity of cultivation receptacles that may be simultaneously housed inside the enclosure; and
wherein said offset is selectively adjustable to thereby allow a retention time of the cultivation receptacles in the enclosure to be set.

2-3. (canceled)

4. The germination unit according to claim 1, wherein the displaceable wall extends along only a part of a height of the germination unit.

5. The germination unit according to claim 1, comprising at least two retractable walls.

6. The germination unit according to claim 5, wherein the displaceable wall is interposed between the at least two retractable walls.

7. The germination unit according to claim 1, wherein the displaceable wall comprises a longitudinal slot configured to allow cultivation receptacles to be transversely displaced therethrough.

8. The germination unit according to claim 7, wherein the longitudinal slot is angularly disposed in the displaceable wall.

9. The germination unit according to claim 7, wherein a circumference of the longitudinal slot is dimensioned in correspondence with a contour of a cultivation receptacle of the rotating horticultural growing system to be displaced therethrough.

10. The germination unit according to claim 1, wherein the input coincides with a location within the germination unit directly adjacent to a backwall of the enclosure arranged opposite the output of the enclosure.

11. The germination unit according to claim 1, wherein the enclosure comprises at least one material from a group of materials, said group comprising a thermally insulating material and a translucent material.

12. A rotating horticultural growing system, comprising:
a guide configured to guide a plurality of cultivation receptacles in a transport direction; and
the germination unit according to claim 1.

13. The rotating horticultural growing system according to claim 12, wherein the displaceable wall defines a partition between a climate controlled germination section and a non-climate controlled growing section of the rotating horticultural growing system.

14. A method for growing a crop, the method comprising:
providing a controllable climate for the germination of crops inside the enclosure of the germination unit according to claim 1; and
adjusting an interior space of the enclosure of the germination unit by adjusting the offset between the input of the guide and an output of the enclosure in dependence of a growth cycle duration of the crop.

15. The method according to claim 14, wherein the step of adjusting the interior space comprises displacing the displaceable wall of the enclosure that comprises the output.

16. (canceled)
